(19) United States
(12) Patent Application Publication
(10) Pub. No.: US 2017/0345596 A1
(43) Pub. Date: Nov. 30, 2017

(54) ELECTROMAGNETIC DEVICE AND ELECTROMAGNETIC RELAY PROVIDED THEREWITH

(71) Applicant: OMRON Corporation, Kyoto-shi (JP)

(72) Inventors: Jun SASAKI, Kumamoto-shi (JP); Kazuhiro TSUTSUI, Kumamoto-shi (JP)

(73) Assignee: OMRON Corporation, Kyoto-shi (JP)

(21) Appl. No.: 15/680,274

(22) Filed: Aug. 18, 2017

Related U.S. Application Data
(63) Continuation of application No. PCT/JP2016/056630, filed on Mar. 3, 2016.

(30) Foreign Application Priority Data
Mar. 18, 2015 (JP) 2015-055292

(51) Int. Cl. H01H 50/36; H01H 50/44

(52) U.S. Cl. CPC H01H 50/36; H01H 50/44

(57) ABSTRACT

An electromagnetic device includes: a coil; a spool having a body, around which the coil is wound, and first and second guard portions provided at both ends of the body, the spool being provided with a through hole in the body, which is opened in the first and second guard portions; an iron core inserted in the through hole; and a yoke being in contact with the second guard portion and fixed with a coupler of the iron core which protrudes from a second-guard-portion-side opening. At least one movement regulator configured to regulate movement of the coil is provided in the body.

### CROSS REFERENCE TO RELATED APPLICATIONS

This application is a continuation application of International Application No. PCT/JP2016/056630, filed on Mar. 3, 2016, which claims priority based on the Article 8 of Patent Cooperation Treaty from prior Japanese Patent Application No. 2015-055292, filed on Mar. 18, 2015, the entire contents of which are incorporated herein by reference.

### TECHNICAL FIELD

The disclosure relates to an electromagnetic device and an electromagnetic relay provided therewith.

### BACKGROUND ART

As an electromagnetic relay, there has been one described in Patent Document 1, for example. This electromagnetic relay is provided with an electromagnetic device that includes a spool, around which a coil is wound and which has a through hole; an iron core inserted in the through hole of the spool, and a yoke caulked and fixed to one end of the iron core. The spool of the electromagnetic device is made of resin, and configured of a body provided with the through hole, and a guard portion provided at each end of this body. The body of the spool has a substantially prismatic shape with a flat surface, and a metal coil is wound therearound.

### PRIOR ART DOCUMENT

### Patent Document

Patent Document 1: Japanese Unexamined Patent Publication No. 2000-260284.

### SUMMARY OF THE INVENTION

### Problems to be Solved by the Invention

In recent years, with the advance in technique, a temperature at the time of soldering an electronic component is greatly on the rise. For example, whereas soldering has hitherto been performed at a temperature of about 230 degrees Celsius in mounting of an electromagnetic relay, soldering is currently performed at a temperature of about 280 degrees Celsius in mounting of an electromagnetic relay on a substrate or the like by lead-free soldering.

Thus, in the case of mounting the above conventional electromagnetic relay by lead-free soldering, a spool thermally expands on a large scale as compared with the case of mounting the same by using the conventional soldering technique. At this time, the coil is simultaneously heated and thermally expands. However, due to a difference in thermal expansion coefficient between the resin spool and the metal coil, when the temperature of the electromagnetic relay returns to its normal temperature, a gap is formed between a guard portion of the spool and the coil. When the electromagnetic relay in this state is vibrated, the coil may move and collide with the guard portion of the spool, causing noise generation.

In view of the foregoing problem, one or more embodiments may provide an electromagnetic device capable of preventing noise generation, and an electromagnetic relay provided with this electromagnetic device.

### Means for Solving the Problem

In order to solve the above problem, an electromagnetic device of one or more embodiments includes: a coil; a spool having a body, around which the coil is wound, and first and second guard portions provided at both ends of the body, the spool being provided with a through hole in the body, which is opened in the first and second guard portions; an iron core inserted in the through hole; and a yoke being in contact with the second guard portion and fixed with one end of the iron core which protrudes from a second-guard-portion-side opening of the spool. At least one movement regulator configured to regulate movement of the coil is provided in the body.

### Effect of the Invention

According to the electromagnetic device of one or more embodiments, the movement regulator can regulate movement of the coil. Hence, even when the electromagnetic device is heated and a gap is formed between the guard portion of the spool and the coil, it is possible to prevent the coil from colliding with the spool. As a result, it is possible to prevent noise generation due to collision of the coil with the spool.

As one or more embodiments, it may be configured such that the movement regulator is provided on the second-guard-portion side from a center between the first and second guard portions in the body.

According to one or more embodiments, the movement regulator can reliably regulate movement of the coil. As a result, it is possible to reliably prevent noise generation due to collision of the coil with the spool.

As one or more embodiments, it may be configured such that the movement regulator has a projecting shape or a recessed shape.

According to one or more embodiments, it is possible to increase the range of design of the electromagnetic device.

The electromagnetic relay of one or more embodiments may include the electromagnetic device.

According to the electromagnetic relay of one or more embodiments, the electromagnetic device can prevent noise generation due to collision of the coil with the spool.

### BRIEF DESCRIPTION OF THE DRAWINGS

FIG. 1 is a diagram illustrating a perspective view of an electromagnetic device in a first embodiment.

FIG. 2 is a longitudinally sectional view of an electromagnetic device, such as in FIG. 1.

FIG. 3 is a perspective view illustrating a state before winding of a coil of an electromagnetic device, such as in FIG. 1.

FIG. 4 is a perspective view illustrating a state before winding of a coil of an electromagnetic device in a second embodiment.

FIG. 5 is a perspective view illustrating a state before winding of a coil of an electromagnetic device in a third embodiment.

FIG. 6 is a view illustrating a partial section of a movement regulator of an electromagnetic device, such as in FIG. 5.

FIG. 7 is a perspective view illustrating a state before winding of a coil of an electromagnetic device in a fourth embodiment.

FIG. 8 is a perspective view illustrating a state before winding of a coil of an electromagnetic device in a fifth embodiment.

FIG. 9 is a perspective view illustrating a state before winding of a coil of an electromagnetic device in a sixth embodiment.

FIG. 10 is a perspective view illustrating Example 2.

FIG. 11 is a perspective view illustrating Comparative Example.

### MODE FOR CARRYING OUT THE INVENTION

Hereinafter, embodiments will be described with reference to the accompanying drawings. In the following description, in describing configurations represented in the drawings, terms showing directions such as “up”, “down”, “left”, and “right”, and other terms including those, will be used. The purpose for using those terms is to facilitate understanding of one or more embodiments through the drawings. Accordingly, those terms do not necessarily show directions used at the time of actually using one or more embodiments. A technical scope of the invention recited in the claims shall not be restrictively interpreted by using those terms.

### First Embodiment

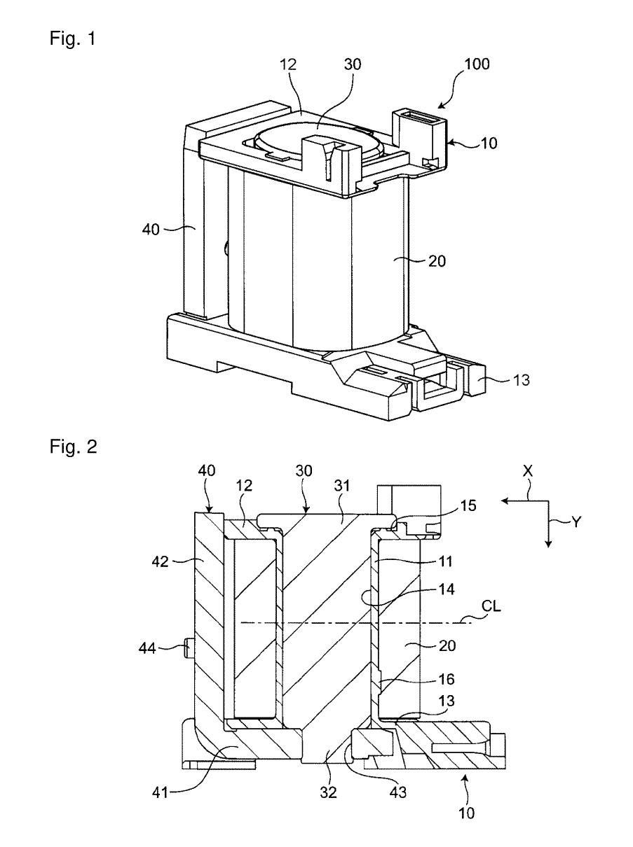

As illustrated in FIGS. 1 and 2, an electromagnetic device 100 of a first embodiment is provided with a spool 10, a coil 20 wound around the spool 10, an iron core 30 inserted in the spool 10, and a yoke 40 caulked and fixed to one end of the iron core 30.

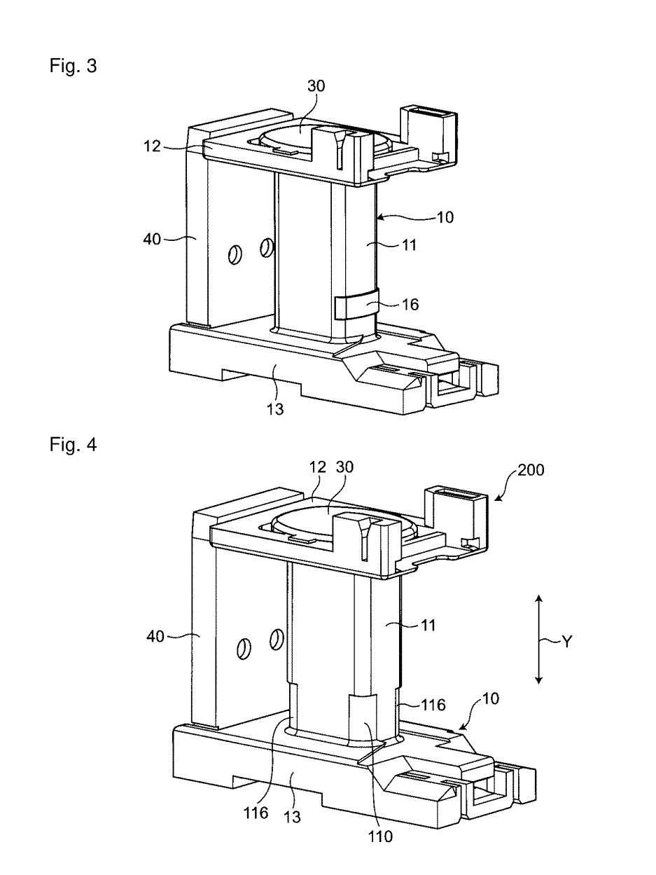

The spool 10 is made up of a body 11, and first and second guard portions 12, 13 provided at both ends of the body 11 and extending in an X-direction. The body 11 has a substantially prismatic shape, and is provided with a through hole 14 that is opened in each of the first and second guard portions 12, 13. An annular step 15 is provided at a first-guard-portion-12-side open edge of the through hole 14. A movement regulator 16 is provided in a second-guard-portion-13-side base portion of the body 11. As illustrated in FIG. 3, this movement regulator 16 has a projecting shape, and is disposed so as to extend from one end to the other end in a shorter direction of the body 11. Further, the movement regulator 16 is provided so as to protrude, from one side surface of the body 11, not smaller than a length corresponding to a diameter of one winding of the coil 20.

The coil 20 is wound around the body 11 of the spool 10. At this time, the coil 20 is wound around the body 11 in the state of being regulated by the movement regulator 16 of the body 11 so as to be prevented from moving toward the first and second guard portions 12, 13. Further, a lead wire, not illustrated, is led out from this coil 20, and wound around a coil terminal, not illustrated.

As illustrated in FIG. 2, the iron core 30 has a substantially cylindrical shape and is formed of a magnetic material. Both ends of this iron core 30 are provided respectively with a magnetic pole portion 31 having a larger diameter size, and a coupler 32 for caulking and fixing to the yoke 40. Further, the iron core 30 is inserted in the through hole 14 of the spool 10. The magnetic pole portion 31 is locked by the annular step 15 of the first guard portion 12, and the coupler 32 protrudes from the second guard portion 13 of the through hole 14.

As illustrated in FIG. 2, the yoke 40 is a substantially L-shaped platy body made of a magnetic material, and configured of a horizontal portion 41 and a vertical portion 42. The horizontal portion 41 has a fitting hole 43 for caulking and fixing the iron core 30, and the Y-directional upper surface of the horizontal portion 41 is in contact with the second guard portion 13. The fitting hole 43 has a fittable shape for the coupler 32 of the iron core 30. Further, the vertical portion 42 has a protrusion 44 for caulking and fixing a movable contact piece, not illustrated.

According to the electromagnetic device 100 with the above configuration, the movement regulator 16 can regulate movement of the coil 20. Thus, even when a gap is formed between the first guard portion 12 of the spool 10 and the coil 20 due to heating of the electromagnetic device 100, it is possible to avoid collision of the coil 20 with the spool 10 at the time of the electromagnetic device 100 being vibrated. Consequently, it is possible to prevent the noise generation due to collision of the coil 20 with the spool 10, and prevent disconnection of the lead wire in association with movement of the coil 20.

### Other Embodiments

The movement regulator 16 is not restricted to a first embodiment. For example, as in an electromagnetic device 200 of a second embodiment illustrated in FIG. 4, a movement regulator 116 having a recessed shape may be provided at each of second-guard-portion-13-side corner portions of the body 11.

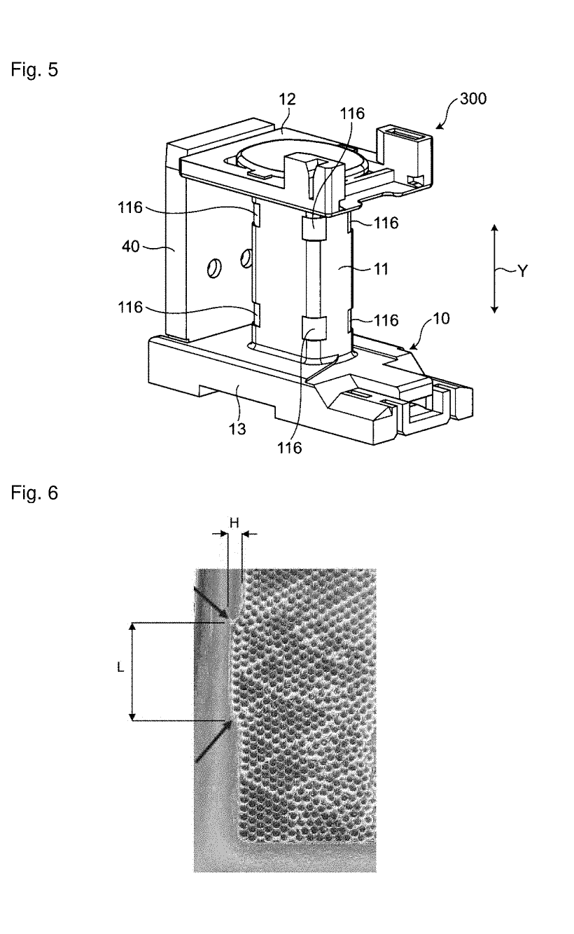

Further, as in an electromagnetic device 300 of a third embodiment illustrated in FIG. 5, the movement regulator 116 having a recessed shape may be provided at each of first-guard-portion-12-side corner portions and second-guard-portion-13-side corner portions of the body 11. That is, at least one movement regulator may simply be provided on the second-guard-portion side from the Y-directional center of the body. Note that as illustrated in FIG. 6, the movement regulator 116 of the electromagnetic device 300 of a third embodiment is provided so as to have a Y-directional length L corresponding to a diameter of about ten windings, and have a height H corresponding to a diameter of about 1.5 windings.

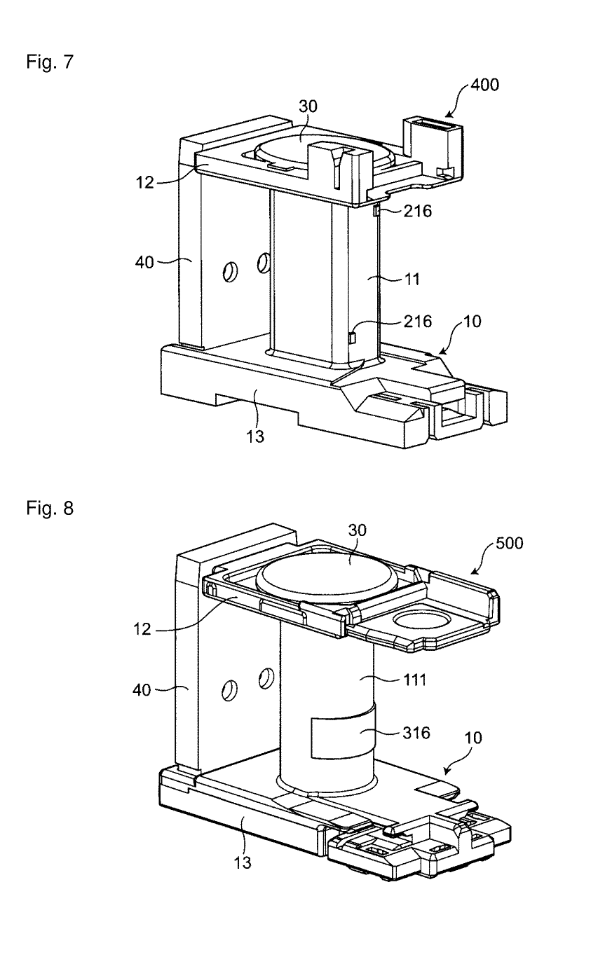

Further, as in an electromagnetic device 400 of a fourth embodiment illustrated in FIG. 7, a movement regulator 216 having a projecting shape may be provided at one end in a shorter direction of one side surface of the body 11 on each of the first-guard-portion-12 side and the second-guard-portion-13 side of the body 11.

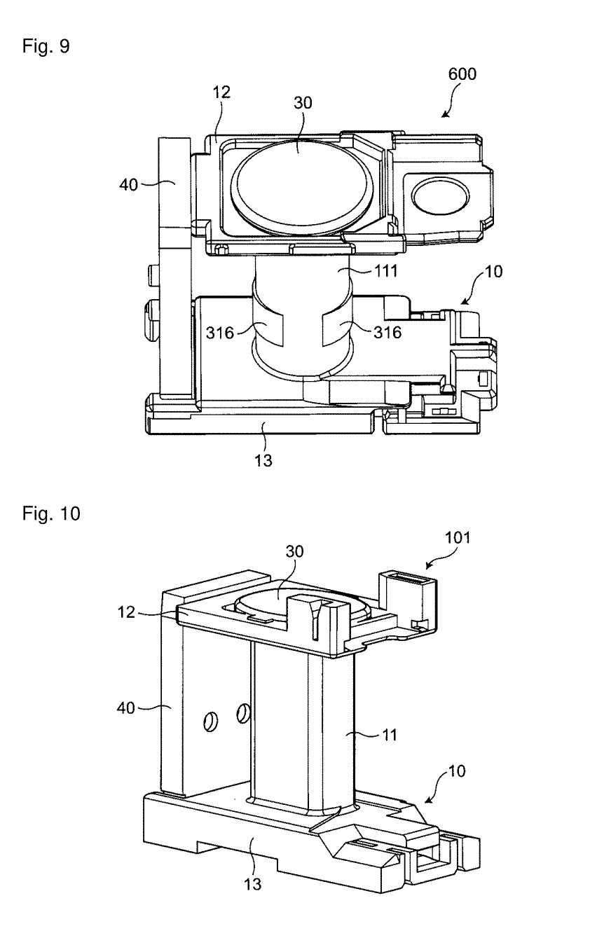

Moreover, as in an electromagnetic device 500 of a fifth embodiment illustrated in FIG. 8, a movement regulator 316 having a projecting shape may be provided on the second-guard-portion-13 side of a body 111 having a cylindrical shape. At this time, only one movement regulator 316 may be provided as in the electromagnetic device 500 of a fifth embodiment, or two movement regulators 316 may be provided as in an electromagnetic device 600 of a sixth embodiment illustrated in FIG. 9.

As thus described, it is possible to employ a movement regulator with its shape, size, and the like freely selected in accordance with design of the electromagnetic device, so long as the movement regulator can regulate movement of the coil. Further, at least one movement regulator may simply be provided on the second-guard-portion side of the body of the spool. It is thus possible to increase the range of design of the electromagnetic device.

Note that, for convenience of description, FIGS. 4 to 8 each illustrate the electromagnetic device in a state before winding of the coil 20.

Electromagnetic devices 100, 200, 300, 400, 500, and 600 of first to sixth embodiments are applicable to the electromagnetic relay, for example.

Naturally, the constituents described in the above embodiments may be appropriately combined, or may be appropriately selected, replaced, or deleted.

### EXAMPLES

### Example 1

The electromagnetic device 100 of a first embodiment was subjected to reflow soldering to the substrate, which was then cooled and vibrated to examine whether or not noise is generated. Ten samples were prepared here to examine whether or not noise is generated for each sample.

In the electromagnetic device 100 of a first embodiment, as illustrated in FIGS. 1 to 3, the movement regulator 16 is provided on the second-guard-portion-13 side from the center between the first and second guard portions 12, 13 in the body 11 of the spool 10.

As a result of the examination, noise was not generated in any of the ten samples of the electromagnetic device 100.

### Comparative Example

An electromagnetic device 101 illustrated in FIG. 10 was subjected to reflow soldering to the substrate, which was then cooled and vibrated to examine whether or not noise is generated. In the same manner as in Example 1, ten samples were prepared to examine whether or not noise is generated for each of the samples.

The electromagnetic device 101 was used which had the same shape and configuration as those of the electromagnetic device 100 in a first embodiment, except for the movement regulator 16. The movement regulator 16 was not provided in this electromagnetic device 101.

As a result of the examination, noise was generated in all of the ten samples of the electromagnetic device 101.

### Example 2

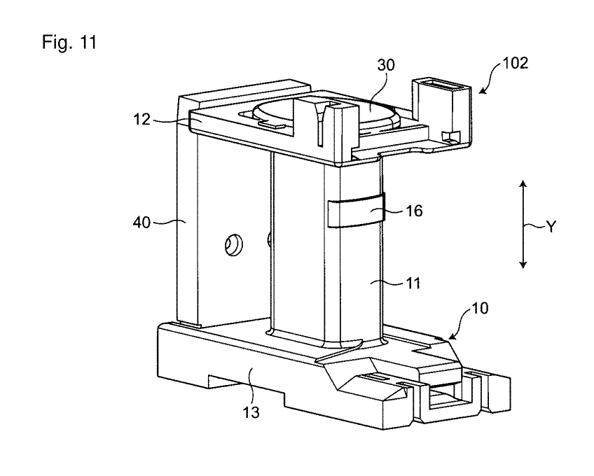

An electromagnetic device 102 illustrated in FIG. 11 was subjected to reflow soldering to the substrate, which was then cooled and vibrated to examine whether or not noise is generated. In the same manner as in Example 1 and Comparative Example, ten samples were prepared to examine whether or not noise is generated for each of the samples.

The electromagnetic device 102 was used which had the same shape and configuration as those of the electromagnetic device 100 in a first embodiment, except for the movement regulator 16. In this electromagnetic device 102, the movement regulator 16 was provided on the first-guard-portion-12 side from the center between the first and second guard portions 12, 13 in the body 11 of the spool 10.

As a result of the examination, noise was generated in three of the ten samples of the electromagnetic device 102.

Consideration

As the results of Examples 1 and 2 and Comparative Example, it was found that providing the movement regulator 16 can prevent noise generation. However, it was found from the results of Examples 1 and 2 that the movement of the coil 20 cannot be sufficiently regulated when the movement regulator 16 is provided on the first-guard-portion-12 side from the center between the first and second guard portions 12, 13 in the body 11 of the spool 10.

This is considered to be due to the following reason: As illustrated in FIG. 2, in the spool 10 of each of the electromagnetic devices 100, 101, 102, the coil 20 regulates X-directional displacement, and the magnetic pole portion 31 of the iron core 30 and the yoke 40 regulate Y-directional displacement. Further, an area where the magnetic pole portion 31 is in contact with the first guard portion 12 is smaller than an area where the horizontal portion 41 of the yoke 40 is in contact with the second guard portion 13. That is, the force of the coil 20 for regulating the Y-directional deformation is stronger on the contact surface between the magnetic pole portion 31 and the first guard portion 12 than the contact surface between the horizontal portion 41 and the second guard portion 13. Thus, when the electromagnetic device 100 is heated by soldering or the like, it thermally expands upward in the Y-direction, namely in a direction from the second guard portion 13 toward the first guard portion 12. As a result, the following consideration is given: when the movement regulator 16 was provided on the first-guard-portion-12 side from the center between the first and second guard portions 12, 13 in the body 11 of the spool 10 as in the electromagnetic device 102 of FIG. 11, the movement regulator 16 was greatly influenced by the thermal expansion to cause occurrence of thermal deformation, such as large movement in the Y-direction, which prevented sufficient regulation on the movement of the coil 20, as compared with the case of providing the movement regulator 16 on the second guard portion 13 side from the center between the first and second guard portions 12 in the body 11 of the spool 10 as in the electromagnetic device 100 of FIG. 3.

Accordingly, it was found preferable to provide the movement regulator 16 in a position where deformation due to a thermal expansion is small and collision of the coil 20 with the spool 10 can be prevented, namely, to provide the movement regulator 16 on the second-guard-portion-13 side from a center CL between the first and second guard portions 12, 13 in the body 11 illustrated in FIG. 2.

### INDUSTRIAL APPLICABILITY

The electromagnetic device of one or more embodiments is not restricted to an electromagnetic relay, but is applicable to other electromagnetic equipment.

### DESCRIPTION OF SYMBOLS

10 spool

11, 111 body

12 first guard portion

13 second guard portion

14 through hole

15 annular step

16, 116, 216, 316 movement regulator

20 coil

30 iron core

31 magnetic pole portion

32 coupler

40 yoke

41 horizontal portion

42 vertical portion

43 fitting hole

100, 101, 102, 200, 300, 400, 500, 600 electromagnetic device

1. An electromagnetic device, comprising:
a coil;
a spool including a body, around which the coil is wound, and first and second guard portions provided at both ends of the body, the spool being provided with a through hole in the body, which is opened in the first and second guard portions;
an iron core inserted in the through hole; and
a yoke being in contact with the second guard portion and fixed with one end of the iron core which protrudes from a second-guard-portion-side opening of the spool,
wherein at least one movement regulator configured to regulate movement of the coil is provided in the body.

2. The electromagnetic device according to claim 1, wherein the movement regulator is provided on the second-guard-portion side from a center between the first and second guard portions in the body.

3. The electromagnetic device according to claim 1, wherein the movement regulator has a projecting shape.

4. The electromagnetic device according to claim 2, wherein the movement regulator has a projecting shape.

5. The electromagnetic device according to claim 1, wherein the movement regulator has a recessed shape.

6. The electromagnetic device according to claim 2, wherein the movement regulator has a recessed shape.

7. An electromagnetic relay comprising the electromagnetic device according to claim 1.

8. An electromagnetic relay comprising the electromagnetic device according to claim 2.
